(19) United States
(12) Patent Application Publication
(10) Pub. No.: US 2008/0165629 A1
(43) Pub. Date: Jul. 10, 2008

(54) Color time

(76) Inventor: Michael A. Billeaudeaux, Auburn, WA (US)

Correspondence Address: Ruttler Law PLLC;One Union Square, 600 University Street, Suite 1730, Seattle, WA, 98101, US

(21) Appl. No.: 12/002,739

(22) Filed: Dec. 18, 2007

Related U.S. Application Data
(60) Provisional application No. 60/875,585, filed on Dec. 19, 2006.

(51) Int. Cl. G04C 19/00

(52) U.S. Cl. 368/82; 368/223

(57) ABSTRACT

This invention relates generally to time, and more specifically, to systems and methods for providing a design that replaces all numbers on a time piece utilizing only three colored shapes which change in specified color based on the hour (12 colors), one sixth of an hour (6 colors) and minute (10 colors) of a day. In one embodiment, the invention includes a timepiece for displaying time using colors, the timepiece having a display, the display configurable to providing a first color, a second color, and a third color, wherein the first color represents minutes, the second color represents increments of ten minutes, and the third color represents hours.

### PRIORITY CLAIM

This application claims the benefit of U.S. Provisional Application No. 60/875,585 filed Dec. 19, 2006. The foregoing application is incorporated by reference in its entirety as if fully set forth herein.

### FIELD OF THE INVENTION

This invention relates generally to time, and more specifically, to systems and methods for providing a design that replaces all numbers on a time piece utilizing only three colored shapes which change in specified color based on the hour (12 colors), one sixth of an hour (6 colors) and minute (10 colors) of a day.

### BACKGROUND

Time is typically provided using a digital display of numbers or by using mechanical hour, minute, and second hands. Although desirable results have been achieved, there exists much room for improvement. What is needed then are systems and methods for providing a design that replaces all numbers on a time piece utilizing only three colored shapes which change in specified color based on the hour (12 colors), one sixth of an hour (6 colors) and minute (10 colors) of a day.

### SUMMARY

This invention relates generally to time, and more specifically, to systems and methods for providing a design that replaces all numbers on a time piece utilizing only three colored shapes which change in specified color based on the hour (12 colors), one sixth of an hour (6 colors) and minute (10 colors) of a day. In one embodiment, the invention includes a timepiece for displaying time using colors, the timepiece having a display, the display configurable to providing a first color, a second color, and a third color, wherein the first color represents minutes, the second color represents increments of ten minutes, and the third color represents hours.

### BRIEF DESCRIPTION OF THE DRAWINGS

Embodiments of the present invention are described in detail below with reference to the following drawings:

FIG. 1 is a time piece utilizing only three colored shapes to provide time, in accordance with an embodiment of the invention;

FIG. 2 is a time piece utilizing only three colored shapes to provide time, in accordance with an embodiment of the invention;

FIG. 3 is a time piece utilizing only three colored shapes to provide time, in accordance with an embodiment of the invention;

FIG. 4 is a time piece utilizing only three colored shapes to provide time, in accordance with an embodiment of the invention;

FIG. 5 is a time piece utilizing only three colored shapes to provide time, in accordance with an embodiment of the invention;

FIG. 6 is a time piece utilizing only three colored shapes to provide time, in accordance with an embodiment of the invention;

FIG. 7 is a time piece utilizing only three colored shapes to provide time, in accordance with an embodiment of the invention;

FIG. 8 is a time piece utilizing only three moving shapes to provide time, in accordance with an embodiment of the invention;

FIG. 9 is a block diagram for a software application that provides time using colored shapes; and

FIG. 10 is a block diagram for a system that provides time using colored shapes.

### DETAILED DESCRIPTION

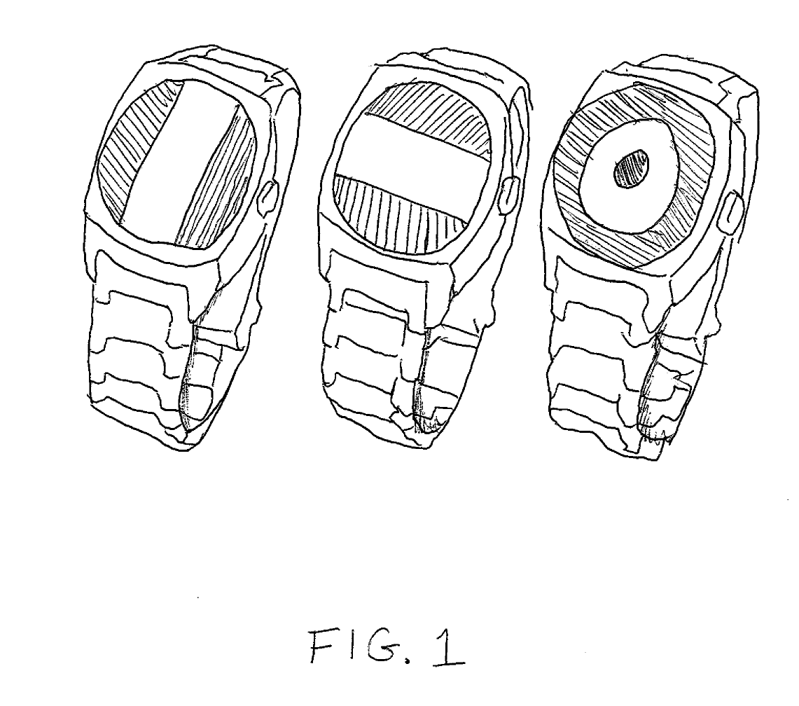

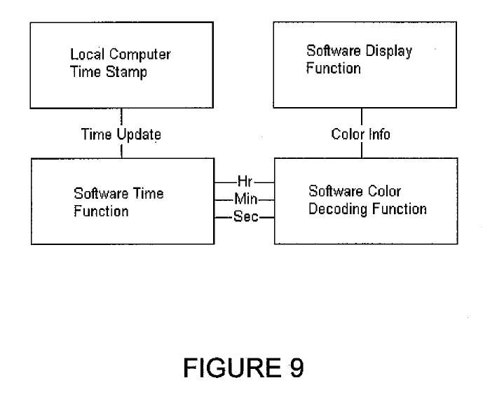

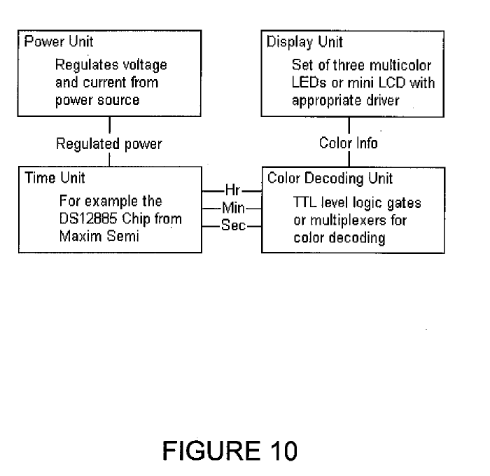

This invention relates generally to time, and more specifically, to systems and methods for providing a design that replaces all numbers on a time piece utilizing only three colored shapes which change in specified color based on the hour (12 colors), one sixth of an hour (6 colors) and minute (10 colors) of a day. Specific details of certain embodiments of the invention are set forth in the following description and in FIGS. 1-10 to provide a thorough understanding of such embodiments.

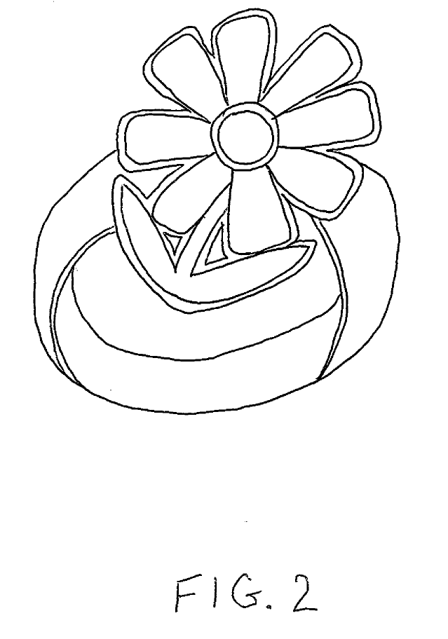

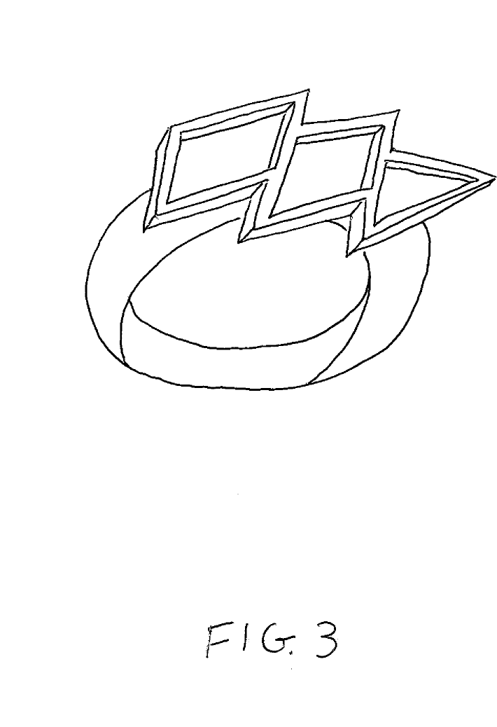

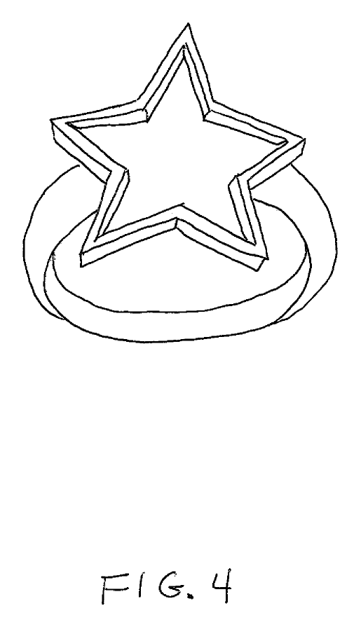

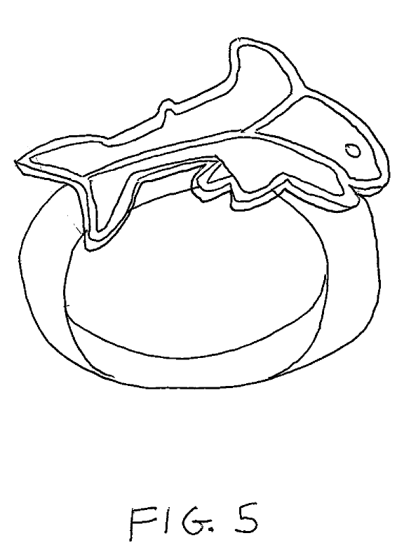

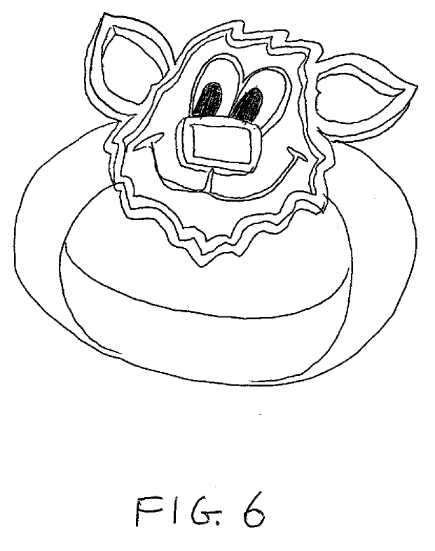

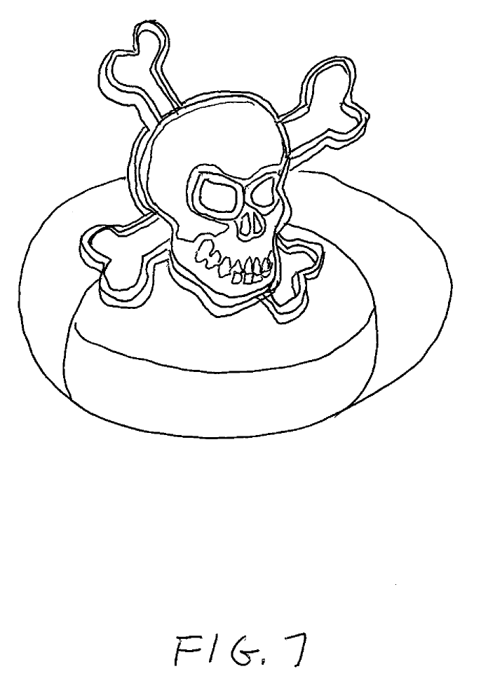

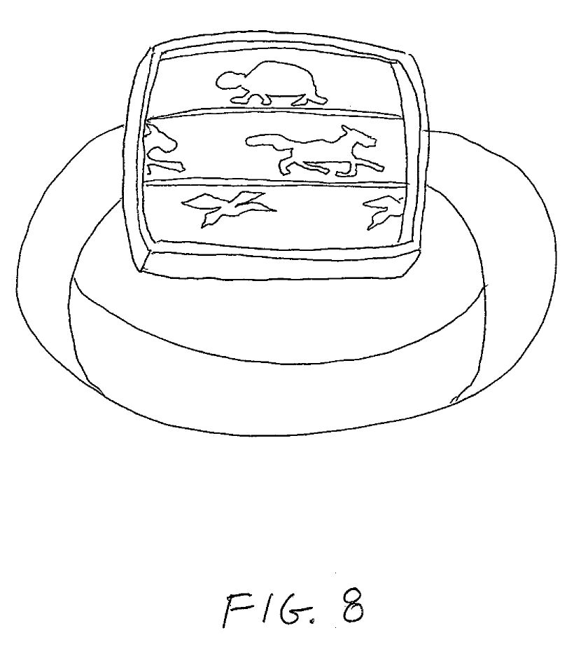

FIG. 1 consists of three designs that support this patent, 3 horizontal bars, 3 vertical bars or concentric circles with each color representing the 1) hour (12 colors); 2) sixth of an hour (6 colors) and 3) minutes (10 colors). Although the drawings are limited to rectangles and circles, the color approach to telling time can manifest itself in many designs such as: flowers, animals, stars or any other design which could host a three color separation. See additional color time supported illustrations: FIG. 2, FIG. 3, FIG. 4, FIG. 5, FIG. 6, FIG. 7 and FIG. 8.

In support of FIG. 1, 3 wrist watches are shown identifying the 3 color use of telling time. Any element however (television screen, projection, cell phone screen, art, jewelry) should be considered as display options. A color palate used can be a combination of any designated 12 colors which would sequentially represent the numbers 1 through 12 to include 0. One of the colors would represent an hour, another would represent ⅙^{th} of an hour or: 10 minute block and the final color would represent minutes. Color to time (numbers and block) correlations might include this example: 1=Yellow; 2=Light Orange; 3=Red; 4=Lt. Green; 5=Dark Green; 6=Turquoise; 7=Navy Blue; 8=Dark Blue; 9=Wine; 10=Purple; 11=Black; and 12 or 0=White. Thus, 10:31 would be pictured on timepiece as: Purple/Red/Yellow; 6:45 would be pictured on timepiece as: Turq/Lt.Grn/Dk Grn; 1:15 would be pictured on timepiece as: Yel/Yel/Dk Grn; 12:57 would be pictured on timepiece as: White/Dk Grn/Nvy Blue; and 12:00 would be pictured on timepiece as: White/Wht/Wht. Time piece should not be limited to watches as it could include cell phones, computers, clocks, billboards, jewelry, projections and computer screens (etc).

“A system for telling time which consists of three colors to be used as indicators of three segments of time (hour, 10 min block or ⅙^{th} hr and minutes) as shown.” “The 3 color time system will be used to tell time on watches, cell phones, computers or any other apparatus where colors can be displayed in an LCD or other light and color emitting or projection system.” “The 3 color time system will not be limited to concentric circles or rectangles but will include designs, such as flowers, stars or animals, where 3 distinct colors can be imposed.”

It is an object of this proposed system to provide a new and improved method for visualizing time. The traditional method of visualizing time consists of a numeric or symbolic representation of the different elements of time (hr, 10 min blocks or ⅙ of an hour, and minutes). This new system proposes the use of color to represent the different elements of time (hr, 10 min blocks or ⅙ of an hour, and minutes). This representation could take many forms as shown in FIGS. 1 through 5. The underlying functional design however will remain constant. The functional design will consist of the following elements: a time keeping unit, a color decoding unit, and a display or light source capable of displaying a sequence of multiple colors. These functional building blocks can exist as software modules or as tangible electronic hardware or even a combination of both software and tangible electronic hardware. The time keeping unit's main function is to keep accurate account of the passing of time. This unit could do so on its own or it could rely on other potential connected devises such as computers or low frequency transmissions from the atomic clock. The color decoding unit is responsible for taking each element of time (hr, 10 min blocks or ⅙ of an hour, and minutes) from the time keeping unit and assigning the correct colors that will represent each element, and passing that on to the display unit. These color representations are pre-determined and always constant as defined in section 5 of this document. Lastly, the display unit will display the colors that are indicated by the color decoding unit for the user to see.

A practicable example of how this system could be implemented as software would be as follows: a software module called the time keeping unit can be written to monitor the time on a local computer. As soon as the time changes the time unit will update and copy the current time. A second software module call the color decoding unit can be written to then in turn monitor the time keeping unit. As soon as the time keeping unit updates the time, the color decoding unit will set to work to do the following: First it will take the time and break it down in to the separate elements of time (hr, 10 min blocks or ⅙ of an hour, and minutes). Then it will assign the correct colors to each element according to the pre-determined table in Section 5 of this document. These colors would then get passed on to the display unit. In this example the display unit might be a computer monitor. In this instance a third module called the display unit could be written that would accept the determined colors from the color decoding unit and then display them in a certain location on the computer monitor. This entire sequence of events would take place as soon as and as often as the time changes on the local computer.

Likewise a real elementary but practicable example of how this system could be implemented as a stand alone tangible electronic device would be as follows: For the time keeping unit the DS12885 real time clock chip from Maxim Semiconductors could be used. This chip would be interfaced with a network of TTL logic gates or multiplexers that will function as the color decoding unit. This in turn could be interfaced to a set of three multi colored LEDs that will display a color as instructed by the color decoding unit. An alternative to the multi colored LEDs could be a small LCD display but this would require some additional LCD driver electronics. The electronic implementation would also require an additional unit for providing and regulating the power to the device.

What is claimed is:

1. (canceled)

2. A timepiece for displaying time using colors, the timepiece comprising:
a display, the display configurable to providing a first color, a second color, and a third color,
wherein the first color represents minutes, the second color represents increments of ten minutes, and the third color represents hours.
